(19) United States
(12) Patent Application Publication
(10) Pub. No.: US 2011/0174261 A1
(43) Pub. Date: Jul. 21, 2011

(54) ROTARY ENGINE WITH ALIGNED ROTOR

(76) Inventors: Glenn L. Havskjold, Canoga Park, CA (US); Mark David Horn, Canoga Park, CA (US); Khin C. Phul, Canoga Park, CA (US)

(21) Appl. No.: 13/121,246

(22) PCT Filed: Oct. 8, 2009
(86) PCT No.: PCT/US09/59959

§ 371 Date: Mar. 28, 2011

Related U.S. Application Data
(60) Provisional application No. 61/103,682, filed on Oct. 8, 2008.

(51) Int. Cl. F02B 53/00

(52) U.S. Cl. 123/200

(57) ABSTRACT

A shaft for a rotary engine defines an axis of rotation, a first eccentric cam axially displaced from a second eccentric cam along the axis of rotation, the first eccentric cam aligned with the second eccentric cam.

The present disclosure claims priority to and incorporates by reference U.S. Provisional Patent Application No. 61/103682, filed Oct. 8, 2008.

### BACKGROUND

The present disclosure relates to a rotary engine.

Engine technology provides various tradeoffs between power density and fuel consumption. Gas turbine engine technology provides reasonably high power densities, but at relatively small sizes, fuel consumption is relatively high and efficiencies are relatively low. Small diesel piston engines have reasonable fuel consumption but may be relatively heavy with power densities typically below approximately 0.5 hp/lb while equivalently sized four-stroke engines have power densities typically below approximately 0.8 hp/lb. Two-stroke engines have greater power densities than comparably sized four-stroke engines, but have relatively higher fuel consumption.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a schematic block diagram view of an exemplary rotary engine;

FIG. 2 is a partial phantom view of an exemplary rotary engine;

FIG. 3 is a partially assembled view of the exemplary rotary engine of FIG. 1 illustrating the first rotor section;

FIG. 4 is a partially assembled view of the exemplary rotary engine of FIG. 1 illustrating the second rotor section;

FIG. 5 is an exploded view of the rotary engine;

FIG. 6 is a longitudinal sectional view of the rotary engine shaft assembly;

FIG. 7 is a perspective view of a shaft for the rotary engine;

FIG. 8 is a perspective view of the shaft with a first rotor and a second rotor mounted thereon in the aligned apex configuration in accords with the instant disclosure; and

FIG. 9 is a graphical representation of first rotor and second rotor lead angle relationships with respect to net power.

### DETAILED DESCRIPTION

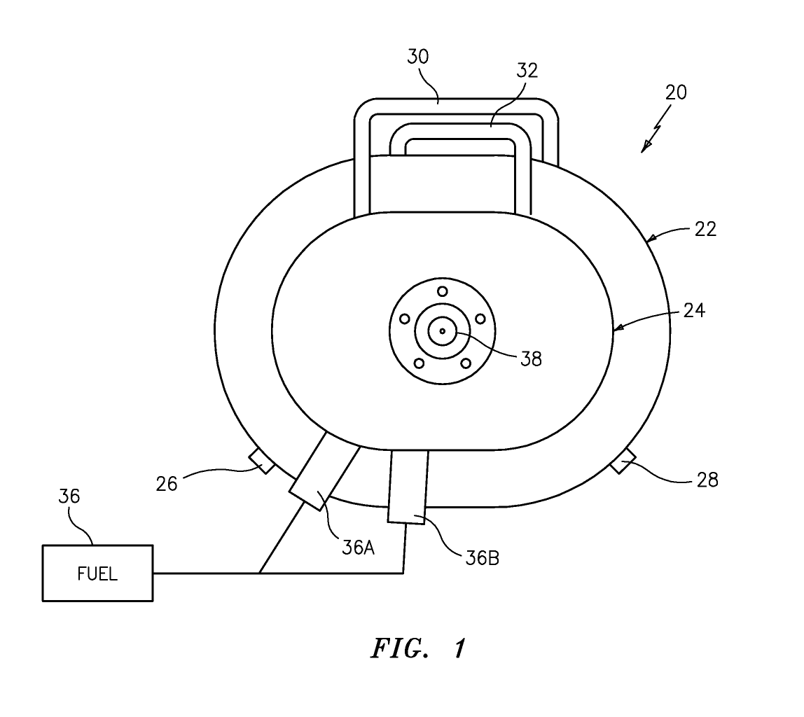

FIG. 1 schematically illustrates a rotary engine 20 having a first rotor section 22 and a second rotor section 24. The rotary engine 20 is based on a rotary, e.g., Wankel-type engine. An intake port 26 communicates ambient air to the first rotor section 22 and an exhaust port 28 communicates exhaust products therefrom. A first transfer duct 30 and a second transfer duct 32 communicate between the first rotor section 22 and the second rotor section 24. A fuel system 36 for use with a heavy fuel such as JP-8, JP-4, natural gas, hydrogen diesel and others communicate with the second rotor section 24 of the engine 20. The engine 20 simultaneously offers high power density and low fuel consumption for various commercial, industrial, compact portable power generation, and aerospace applications.

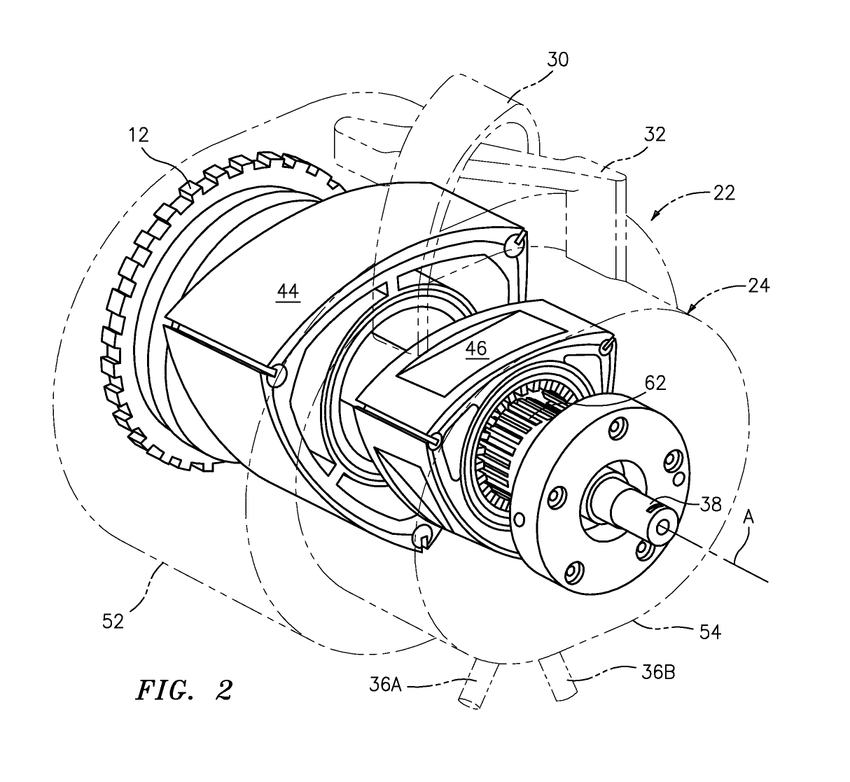

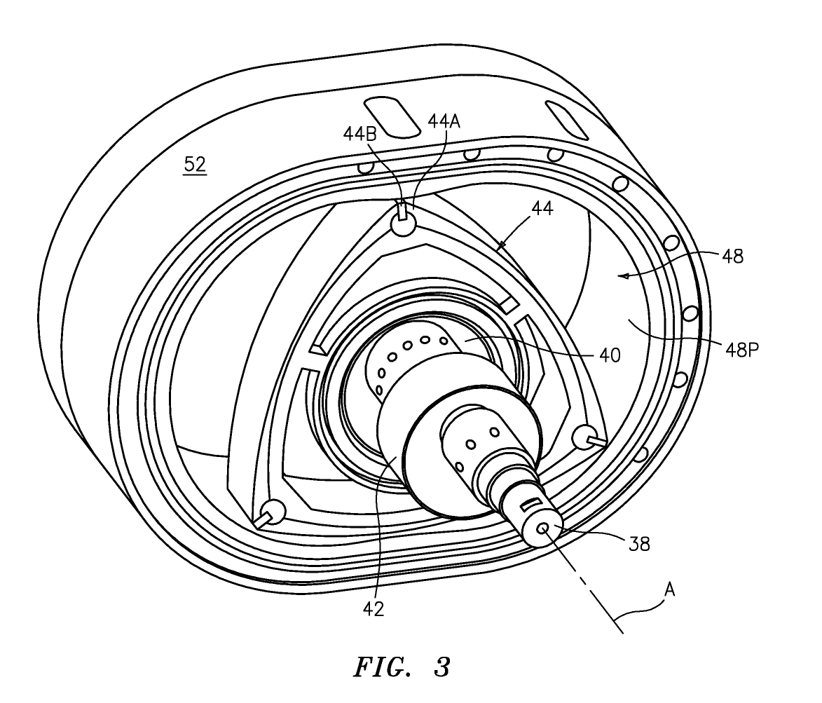

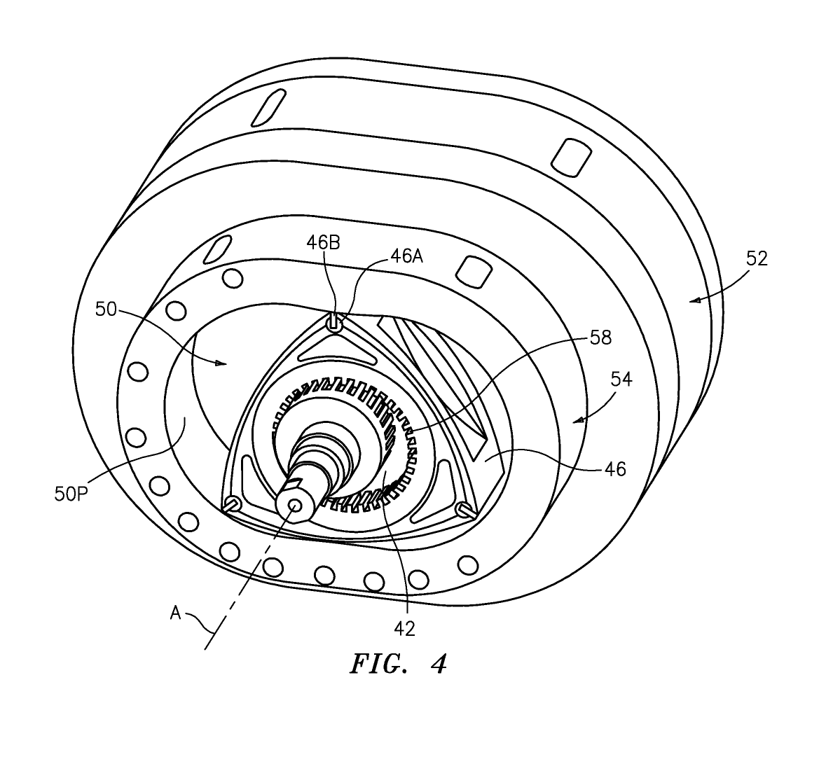

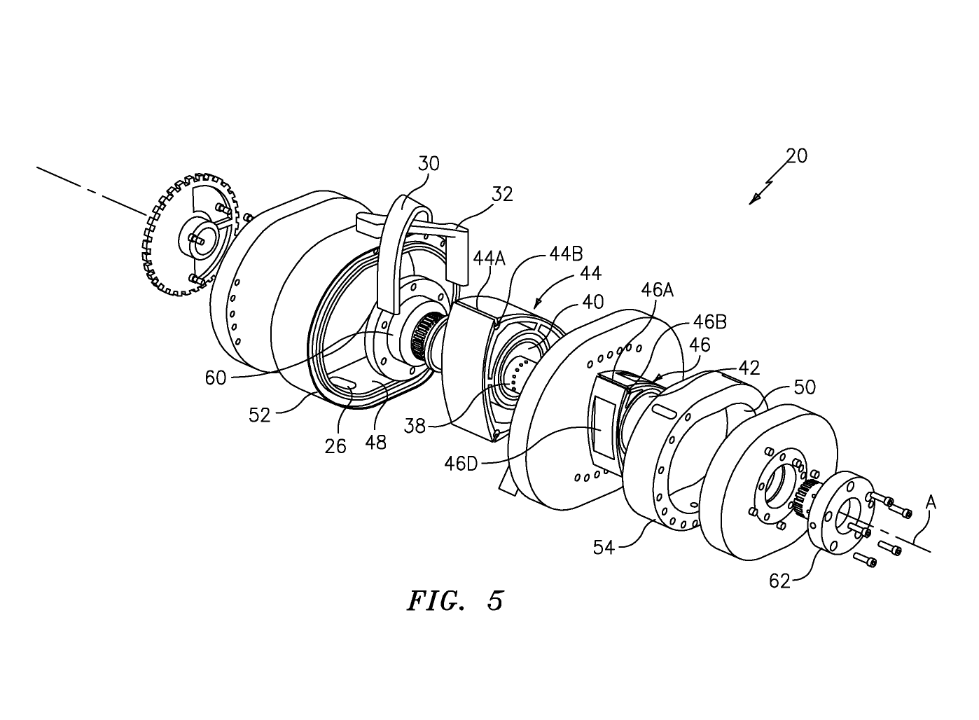

Referring to FIG. 2, the rotary engine 20 generally includes at least one shaft 38 which rotates about an axis of rotation A. The shaft 38 includes aligned eccentric cams 40, 42 (FIGS. 3 and 4) which drive a respective first rotor 44 and second rotor 46 which are driven in a coordinated manner by the same shaft 38. The first rotor 44 and second rotor 46 are respectively rotatable in volumes 48, 50 formed by a stationary first rotor housing 52 and a stationary second rotor housing 54 (FIGS. 3 and 4). The fuel system 36, in one non-limiting embodiment, includes one or more fuel injectors with two fuel injectors 36A, 36B shown in communication with the second rotor volume 50 generally opposite the side thereof where the transfer ducts 30, 32 are situated in one non-limiting embodiment. It should be understood that other fuel injector arrangement, locations and numbers may alternatively or additionally be provided. The fuel system 36 supplies fuel into the second rotor volume 50. The first rotor volume 48 in one non-limiting embodiment provides a greater volume than the second rotor volume 50. It should be understood that various housing configurations shapes and arrangements may alternatively or additionally be provided (FIG. 5).

The first rotor 44 and the second rotor 46 have peripheral surfaces which include three circumferentially spaced apexes 44A, 46A respectively. Each apex 44A, 46A includes an apex seal 44B, 46B, which are in a sliding sealing engagement with a peripheral surface 48P, 50P of the respective volumes 48, 50. The surfaces of the volumes 48, 50 in planes normal to the axis of rotation A are substantially those of a two-lobed epitrochoid while the surfaces of the rotors 44, 46 in the same planes are substantially those of the three-lobed inner envelope of the two-lobed epitrochoid.

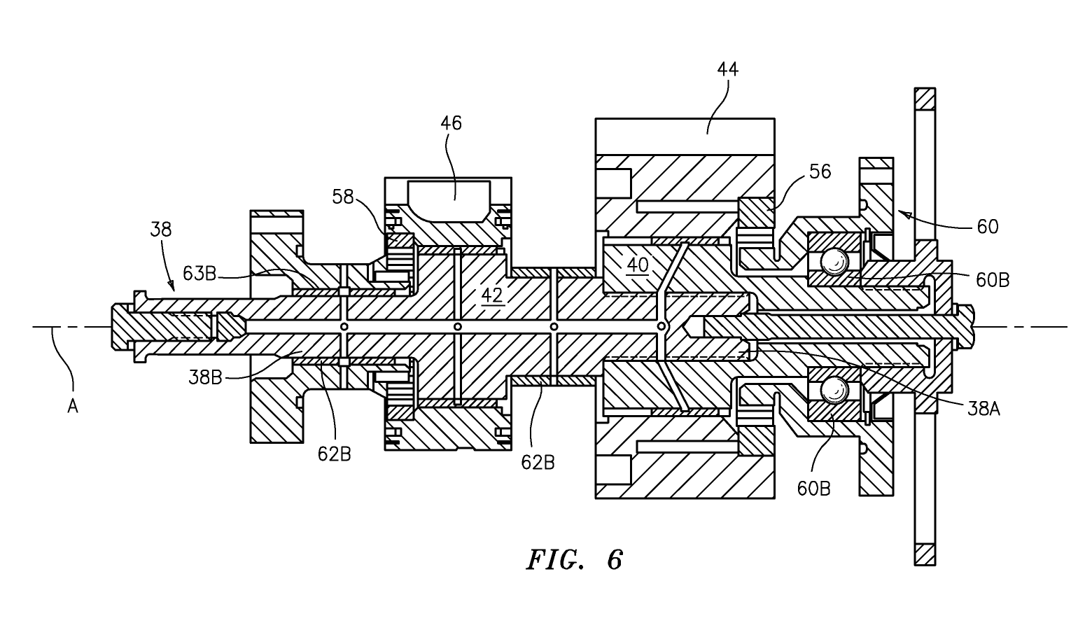

Referring to FIG. 6, the rotors 44, 46 are mounted to a respective external gear 56, 58 which are in meshed engagement with complementary rotationally stationary gears 60, 62 mounted about axis A to provide coordinated rotation. The first rotor stationary gear 60 may be located between a first end section 38A of the shaft 38 and the first rotor cam 40. The second rotor stationary gear 62 may be located between a second end section 38B of the shaft 38 and the second rotor cam 42. The first rotor cam 40 drives the first rotor 44 as the first rotor stationary gear 60 is in meshed engagement with the first rotor external gear 56 while the second rotor cam 42 drives the second rotor 46 as the second rotor stationary gear 62 is in meshed engagement with the second rotor external gear 58 such that the first rotor 44 and the second rotor 46 run in the same angular sense and at the same rotational speed.

In operation, air enters the engine 20 through the intake port 26 (FIG. 1). The first rotor 44 provides a first phase of compression and the first transfer duct 30 communicates the compressed air from the first rotor volume 48 to the second rotor volume 50 (FIGS. 2 and 3). The second rotor 46 provides a second phase of compression, combustion and a first phase of expansion, then the second transfer duct 32 communicates the exhaust gases from the second rotor volume 50 to the first rotor volume 48 (FIGS. 2 and 4). The first rotor 44 provides a second phase of expansion to the exhaust gases, and the expanded exhaust gases are expelled though the exhaust port 28 (FIGS. 1 and 2). The shaft 38 completes one revolution for every cycle, so there are three (3) crank revolutions for each complete rotor revolution. As each rotor face completes a cycle every revolution and there are two rotors with a total of six faces, the engine produces significant power within a relatively small displacement.

The shaft 38 may include axially separable sections which, in one non-limiting embodiment, may be separable between the cams 40, 42 to facilitate assembly. Alternatively or additionally, the first rotor cam 40 and the second rotor cam 42 may also be separable sections. The separable sections of the shaft 38 may be assembled through a tie rod or other fastener arrangement to facilitate assembly such as assembly of the rotationally stationary gears 60, 62.

The shaft 38 may also support bearings 60B, bushings 62B or other low-friction devices about enlarged shaft portions 38C. The enlarged shaft portions 38C permit relatively larger diameter bearings, bushings or other low-friction devices to provide a robust and reliable interface which increase structural rigidity and reduce lubrication requirements.

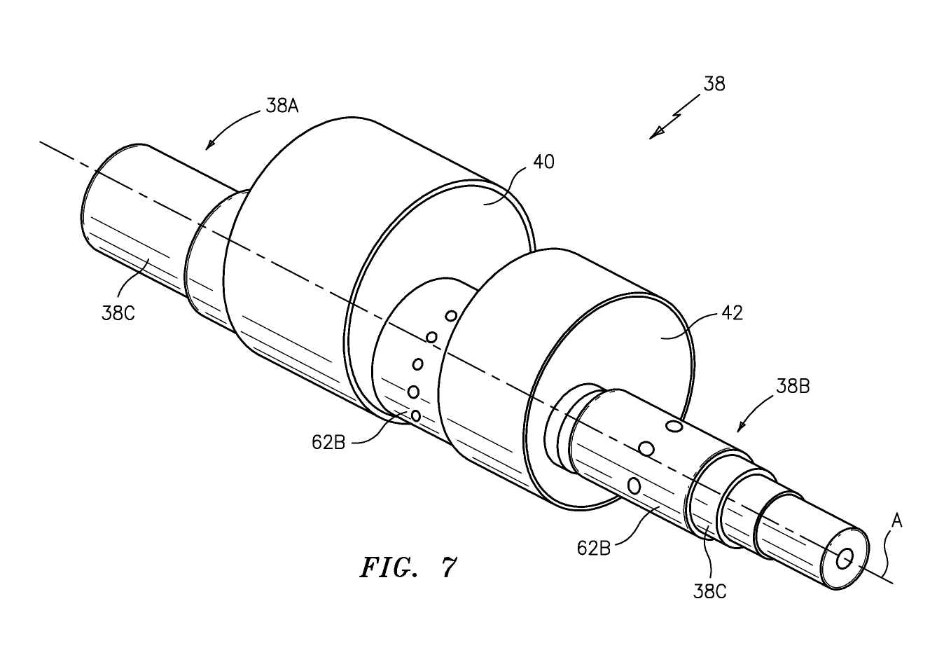

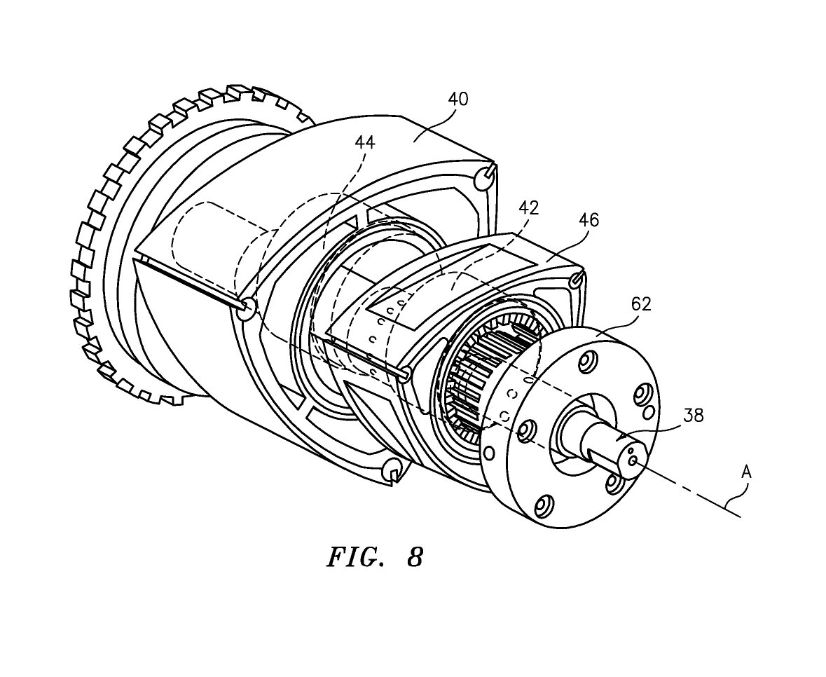

Referring to FIG. 7, the first rotor cam 40 and the second rotor cam 42 are aligned such that the first rotor 44 and the second rotor 46 operate in an apex aligned configuration (FIG. 8). That is, each apex 44A of the first rotor 44 is aligned with each apex 46A of the second rotor 46 and the respective eccentric cams 40, 42 are aligned. In one non-limiting embodiment, each apex 44A of the first rotor 44 is within twenty (20) degrees of each apex 46A of the second rotor 46 and the eccentricity of the respective cams 40, 42 are within sixty (60) degrees of each other. In other examples, the respective apexes 44A, 46A are within fifteen degrees of each other or within 10 degrees of each other. The first rotor cam 40 may be of a different size than the second rotor cam 42.

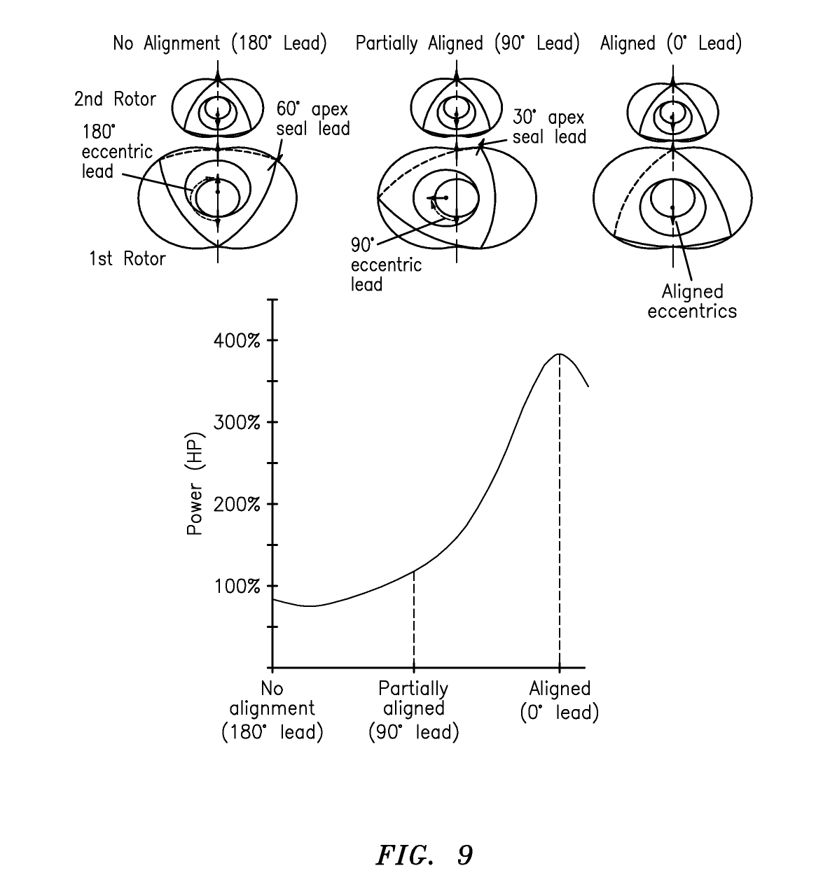

Referring to FIG. 9, the apex aligned configuration provides net power output effects as compared to a lead angle arrangement in which the cams 40, 42 are not aligned. In a non-aligned arrangement, power is relatively low. In like manner, power increases as the cams 40, 42 become aligned. The apex aligned configuration minimizes the length and the subsequent volume of the first and second transfer duct 30, 32 which substantially increases power, efficiency and structural rigidity yet reduces engine mass and packaging considerations. The aligned rotor configuration also facilitates transfer port timing which still further increases power and efficiency by maximizing the mass transfer between the first and second rotor 44, 46, both on the compression and expansion phases of the cycle.

It should be understood that like reference numerals identify corresponding or similar elements throughout the several drawings. It should also be understood that although a particular component arrangement is disclosed in the illustrated embodiment, other arrangements will benefit herefrom.

Although particular step sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

1-4. (canceled)

5. A rotary engine comprising:
a shaft including a first cam and a second cam, the first cam axially displaced from the second cam;
a first rotor mounted at least partially around the first cam, the first rotor having a rotor apex portion; and
a second rotor mounted at least partially around the second cam, the second rotor having a rotor apex portion, wherein the rotor apex portion of the first cam are aligned with the rotor apex portion of the second cam.

6. (canceled)

7. The rotary engine of claim 5, wherein the respective rotor apex portions are aligned within twenty (20) degrees of each other.

8-9. (canceled)

10. A rotary engine comprising:
a first rotor which provides a first phase of compression; and
a second rotor in communication with said first rotor to provide a second phase of compression, a combustion and a first phase of expansion, said second rotor in communication with said first rotor to provide a second phase of expansion, said first rotor and said second rotor rotated by a single shaft such that each apex of said respective first rotor and said second rotor are aligned.

11. The rotary engine as recited in claim 10, wherein each apex of said respective first rotor and said second rotor are aligned within twenty (20) degrees.

12. The rotary engine as recited in claim 10, wherein said first rotor defines a rotor periphery greater than said second rotor.

13. The rotary engine as recited in claim 10, wherein first rotor is mounted at least partially around a first eccentric cam of said shaft and said second rotor is mounted at least partially around a second eccentric cam of said shaft.

14. The rotary engine as recited in claim 10, wherein, said first rotor defines three circumferentially spaced first rotor apexes and said second rotor defines three circumferentially spaced second rotor apexes.

15. (canceled)
